(19) United States
(12) Patent Application Publication
(10) Pub. No.: US 2007/0257120 A1
(43) Pub. Date: Nov. 8, 2007

(54) Tabbed interface for thermostat

(75) Inventors: John Gilman Chapman JR., Delaware, OH (US); Robert Burt, Columbus, OH (US); Tony Gray, Dublin, OH (US)

Correspondence Address: REINHART BOERNER VAN DEUREN P.C., 2215 PERRYGREEN WAY, ROCKFORD, IL, 61107, US

(73) Assignee: Ranco Incorporated of Delaware, Wilmington, DE (US)

(21) Appl. No.: 11/416,053

(22) Filed: May 2, 2006

(51) Int. Cl. G05D 23/00

(52) U.S. Cl. 236/94

(57) ABSTRACT

A digital thermostat having an improved user display interface is provided. The digital thermostat includes a user display screen for displaying information and user input devices for allowing the user to input information into the thermostat. The thermostat includes a user display interface that displays some information or groupings of information on the user display screen of the digital thermostat in a tabbed configuration. An individual grouping of information that is displayed on the user display screen in the tabbed configuration has an individual tab for identifying that specific grouping of information. Preferably, the user display screen is a touch screen and the individual tabs act as buttons and allow the user to interact with the thermostat.

### FIELD OF THE INVENTION

This invention generally relates to digital thermostats, and more particularly to a display system for a digital thermostat to convey information to a user.

### BACKGROUND OF THE INVENTION

Occupants of dwellings and commercial structures have long benefited from the inclusion of a heating, ventilating, and air conditioning (HVAC) system that regulates the temperature, humidity and air-quality within the dwelling or structure. Traditionally, a thermostat that controlled this temperature regulating equipment was a fairly simple electromechanical device wired to a heating device and/or to a cooling device. Once installed, the user need only move a selector switch between heating and cooling to designate which equipment was desired to be operated, move a selector switch between run and auto for a fan control, and rotate a dial to a desired set point temperature. No other user interface to the basic thermostat was needed or available.

Advances in control electronics have allowed the development of new, digital thermostats that may be programmed by a user to control the heating and cooling equipment in a much more energy efficient manner than the older electromechanical devices. These modern digital thermostats allow programming that can automatically set back the heat, for example, during periods when the dwelling or structure is not occupied, and can turn up the heat just prior to and during periods of occupation of the dwelling or structure. Indeed, many such digital thermostats allow for different programming options during different days of the week. For example, such a digital thermostat may provide for one programmed operation during the week and a different programmed operation on the weekend, to accommodate the different usage patterns of the occupants of that particular dwelling or structure.

While the advances that are being included in modern digital thermostats greatly enhance the user's comfort level and minimize the energy usage, the overall user experience interfacing with such a digital thermostat has not kept pace. Specifically, while such digital thermostats typically provide some form of user interface screen from which information is conveyed to the user, and from which the user may program the operation of the thermostat, such displays are not configured to adequately display the increasing amount of information provided by and required to be programmed into the thermostat.

As the amount of information that must be displayed on the user interface screen increases, it implies that the size of the screen must increase as well. However, if the size of the screen increases, so does the physical size of the thermostat, which is not an optimum solution. Thus, only a portion of relevant information may be displayed on the user interface screen at a time. Typically, to view all the information, the user must scroll through lists of information. Unfortunately, the current method of using a scrolling list can make the information flow complicated and confusing for users. Specifically, users may be required to read through a list several times to make sure they have not skipped any choices during cycling of the list. Furthermore, users may not be able to tell if more information is available or where in the list they currently are.

In other information displaying situations, such as where a user is programming a number of various operational modes, the user may want to easily jump from one mode to the other mode. Typically, a user will have to exit out of a first mode and return to a main menu screen before the user can enter a new mode. This can be frustrating and time consuming when the user wants to set multiple modes at one time. Furthermore, some users tend to forget which mode they have selected and then must exit the mode and reenter it.

There exists, therefore, a need in the art for an display system for a digital thermostat that provides an improved display configuration for large quantities of information and/or that provides easy programming and switching between similar types of information.

The invention provides such a digital thermostat display. These and other advantages of the invention, as well as additional inventive features, will be apparent from the description of the invention provided herein.

### BRIEF SUMMARY OF THE INVENTION

The present invention provides a new and improved digital thermostat. More particularly, present invention provides a new and improved digital thermostat having an improved and more efficient display system for displaying information on a user display screen of the thermostat in a less confusing manner. Particularly, the thermostat includes a user display screen for displaying information to a user.

In an embodiment of the present invention, the thermostat displays information on the user display screen using in a tabbed configuration. To provide the tabbed configuration, the user display screen displays a tabbed visual identifier that represents a grouping of information. The thermostat further includes user input devices for relaying information to the thermostat by the user.

In a preferred embodiment of the present invention, the user display screen may be a touch screen such that the user display screen and input devices are combined in a single unit. In embodiments that utilize a touch screen, it is an aspect of the present invention that the displayed tabbed visual identifiers function as buttons that the user may push to cycle between various pages of information.

In an alternate embodiment, the user display screen is a dot matrix liquid crystal display (LCD) without touch screen capabilities. In this embodiment the thermostat includes soft keys for inputting information into the thermostat.

In an embodiment, the groupings of information displayed on the user display screen include multiple pages of a list. In another embodiment, the groupings of information include separate groups of information corresponding to different operational states of the thermostat.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a top view illustration of an embodiment of a thermostat constructed in accordance with the teachings of the present invention;

FIGS. 2-8 illustrate user display screens generated by and usable with the embodiment of the thermostat of the present invention illustrated in FIG. 1; and

FIG. 9 is a top view illustration of an alternative embodiment of a thermostat constructed in accordance with the teachings of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

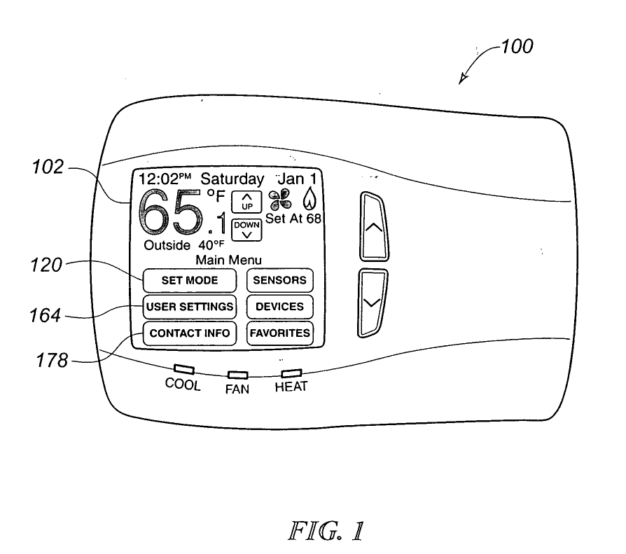

Referring now to the figures, FIG. 1 illustrates an embodiment of a thermostat 100, constructed in accordance with the teachings of the present invention. The thermostat 100 is an intelligent digital thermostat with a primary function of controlling a heating, ventilating, and air conditioning system (HVAC system) of a dwelling or structure. As with many thermostats, the thermostat 100 preferably includes an internal temperature sensor that is monitored by an internal electronic processor of thermostat 100 to determine when to activate and/or deactivate the HVAC system.

The thermostat 100 is referred to as an intelligent thermostat because the electronic processor is programmed to perform many functions other than simply activating and deactivating the HVAC system. Some of these functions include implementing selected ones of multiple operating modes that may be preprogrammed or user programmed to more efficiently control the HVAC system and enhance the comfort of the occupants. The thermostat may implement and initiate these modes based on numerous characteristics of the environment of the dwelling or structure. For example, the modes can be selected or initiated in response to user determined or sensor determined changes in occupancy of the dwelling or structure, time of day, etc. Alternatively, the user may manually activate a mode.

The thermostat 100 may be programmed to use or analyze information gathered by it or sent to it by other appliances in the dwelling or structure to more accurately control the HVAC system as well as the appliances in response to changes in environmental conditions throughout the dwelling or structure. For example, heat producing appliances may require preemptive and/or localized conditioning of their environments within the dwelling or structure such as the kitchen, laundry, or bathroom. Furthermore, the thermostat 100 may be programmed to prevent operation of or set operational modes of the appliances depending on the operating mode selected for the HVAC system, such as a vacation mode, to reduce energy consumption.

The thermostat 100 may be programmed to include communications technology, such as wireless communications technology, to communicate with the appliances in the dwelling or structure. Alternatively, the communications technology may be used to automatically report information such as errors in operation of the HVAC system to remote manufacturer support centers or occupancy information gathered by the occupancy sensors to remote security support centers or to user defined communication devices such as cellular phones, email accounts, or text messaging devices.

Thus, it will be appreciated that the thermostat 100 may be programmed to be extremely intelligent and flexible by processing large quantities of data that is preprogrammed, gathered by the thermostat 100 or input by the user. These identified functions discussed herein are provided by way of example only, and in no way are exhaustive or limit the scope of the invention.

The thermostat 100 of the present invention includes a user display screen 102 on which may be displayed the programmatic, system, ambient, control and like information regarding the operational state of the HVAC system and other relevant devices. Further, the user display screen 102, in part, allows the user to interact with and communicate back-and-forth with the thermostat 100. In a preferred embodiment of the present invention, the user display screen 102 is a dot matrix LCD touch screen display. With a touch screen user display screen 102, the user can directly touch visually demarcated zones on the user display screen 102 that function as buttons for the user to select, toggle between, or to alter the information displayed on the user display screen 102. These buttons can be used to navigate through the various menus and screens displayed on the user display screen 102, as will more fully be explained below.

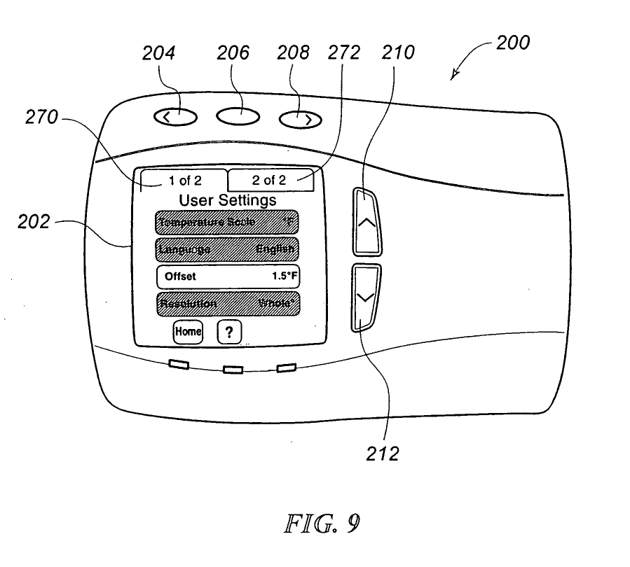

In an alternative embodiment illustrated in FIG. 9, the user display screen 202 is a dot matrix LCD display without touch screen capabilities. In this embodiment, the thermostat 200 includes a plurality of soft keys 204-212 that are depressible by the user to input information into and navigate through various screens and menus of the thermostat 200. The particular functionality executed by these soft keys 204-212 varies dependent upon the programmatic state in which the thermostat 200 is operating at the time one of the soft keys 204-212 is depressed. As this embodiment is displayed having a dot matrix LCD display, the embodiment could utilize other user display screens such as a static-LCD display. The embodiment without the touch screen display will be discussed more fully below.

Having identified the physical structure of several embodiments of thermostats 100, 200 constructed in accordance with the teachings of the present invention, the discussion will now focus on the visual display and interface of the thermostat, which forms an aspect of the present invention. While the following discussion will reference the structure of the thermostat 100 illustrated in FIG. 1, those skilled in the art will recognize that the structure of FIG. 9 and various other structures can be utilized without departing from the spirit and scope of the present invention. That is, regardless of the user input mechanisms utilized by the particular embodiment of the thermostat of the present invention, the beneficial display configuration provided in the following discussions may be used.

As is evident from the above description, intelligent thermostats are becoming increasingly more complex as they are programmed to control and communicate with many devices of the dwelling or structure and to perform many tasks. With the function and capabilities of the thermostat becoming increasingly complex, the amount of information that needs to be displayed on the user display screen 102 as well as input into the thermostat 100 increases. Thus, it is important for the user display screen 102 to provide an organized and user friendly interface and display configured to facilitate communicating information to and receiving information from the user. It is therefore an aspect of the present invention to provide a thermostat 100 having an improved user interface.

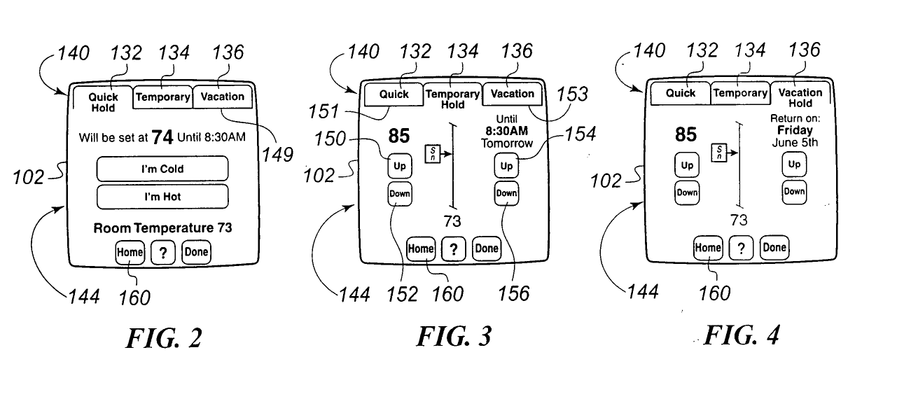

Specifically, the thermostat 100 of an embodiment of the present invention is programmed to display some information to the user more efficiently by displaying various groupings of information on the user display 102 in a tabbed display configuration. The configuration of the improved user interface by which some information is displayed by the thermostat 100 on the user display screen 102 according to teachings of the present invention may be better understood with reference to the screen shots of the user display screen illustrated in FIGS. 2-8.

One example of using the tabbed display configuration is illustrated by FIGS. 2-5, which illustrate representative screen shots of the SET MODE function for setting operational modes of the HVAC system. The representative operational modes include a QUICK HOLD mode, a TEMPORARY HOLD mode, and a VACATION HOLD mode. It should be noted, however, that the particular modes identified in the example are provided by way of example only, and in no way limit the scope of the invention. Each mode has a corresponding grouping of information that is displayed when the user programs operational parameters of the mode, such as a set temperature for the HVAC system or the length of time for operating in the mode when selected.

Typically, the user will access the SET MODE function and representative screens of FIGS. 2-5 by pressing a SET MODE button 120 or like identified button of a MAIN MENU screen (see FIG. 1). After selecting the MODE button 120 from the MAIN MENU screen, the user display screen 102 changes to a screen having a set of tabs 132, 134, 136 as illustrated in FIG. 2. Each tab 132, 134, 136 identifies and/or represents an individual grouping of information. Further, the user display screen 102 will display one of the groupings of information.

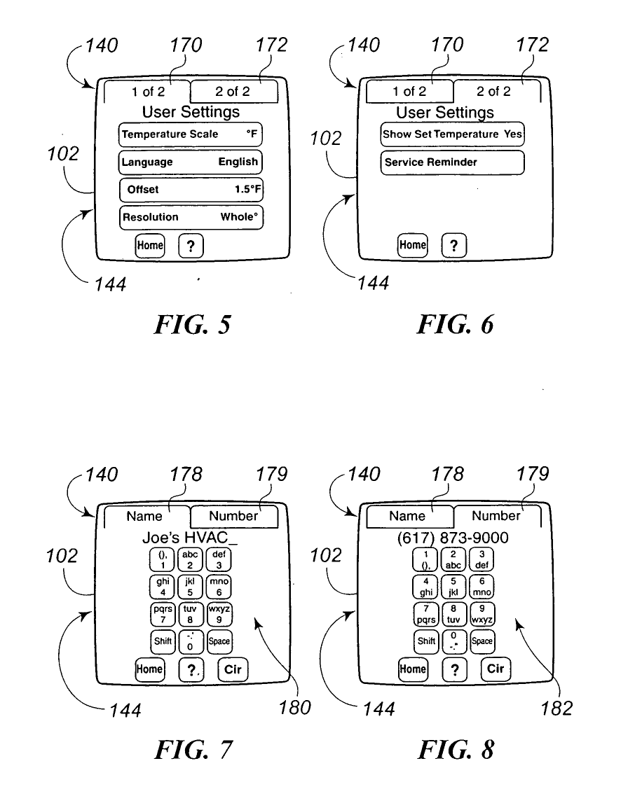

Specifically, the tabs 132, 134, 136 are displayed in an upper tab region 140 of the user display screen 102, while the displayed grouping of information is displayed in a lower, and typically larger, information display region 144 of the user display screen 102. As illustrated, typically, the upper tab region 140 extends laterally across and is proximate the top of the user display screen 102 as well as is proximate the information display region 144. Additionally, the tabs 132, 134, 136 are positioned side-by-side as they extend laterally across the user display screen 102. Additionally, the tabs 132, 134, 136 are justified across the screen. Thus, because there are three tabs, each takes up one-third the width of the user display screen 102. When there are two tabs, see e.g. FIG. 5, each tab takes up one-half the width of the user display screen 102. In an embodiment, the first grouping of information that is displayed in the information display region 144 corresponds to the first tab in the set of tabs. One of skill in the art will recognize that the tabs may be in other positioned such as positioned proximate a vertical edge of the user display screen 102 and multiple rows of tabs may be provided.

In the illustrated embodiment, the first tab in the group of tabs is the QUICK HOLD tab 132. Consequently, the grouping of information that is displayed on the user display screen 102 in the information display region 144 is programmatic and control information corresponding to the QUICK HOLD mode. The user may identify that the information displayed in the information display region 144 corresponds to the QUICK HOLD mode because the QUICK HOLD tab 132 is displayed in a selected condition, while the other tabs 134, 136 for the other modes are displayed in an unselected condition.

In the selected condition, the portion of the tab region 140 displaying the QUICK HOLD tab 132 is displayed such that it appears to the user as being integral with the information display region 144, i.e. nothing separates the text “QUICK HOLD” from the information display region 144. Furthermore, the TEMPORARY HOLD tab 134 and VACATION HOLD tab 136 are displayed as being in the unselected condition such that these tabs 134, 136 are displayed as being separated from the information display region 144. Particularly, a horizontal line 149 extending laterally from the QUICK HOLD tab 132 toward an edge of the display screen 102 and positioned vertically between a portion of the text of the TEMPORARY HOLD and VACATION HOLD tabs 134, 136 and the information display region 144 separates the TEMPORARY HOLD and VACATION HOLD tabs 134, 136 from the information display region 144.

The tabs 132, 134, 136 operate to do more than identify the grouping of information currently displayed in the information display region 144 of the user display screen 102. With respect to the user display screen 102 of the present embodiment having touch screen capabilities, the tabs 132, 134, 136, themselves, function as buttons. This feature allows the user to easily cycle between the various modes by merely pressing the location of the user display screen 102 displaying the tab of the mode that the user desires to select and/or to modify.

When the user switches from one mode to another mode, the tab for the newly selected mode is switched to being displayed in the selected condition, while the previously selected tab is switched to being displayed in the unselected condition. This is illustrated with further reference to FIGS. 3 and 4. For instance, if the user switches from the QUICK HOLD mode (FIG. 2) to the TEMPORARY HOLD mode (FIG. 3), the user selects the TEMPORARY HOLD tab 134 by pressing the portion of the user display screen 102 displaying the TEMPORARY HOLD tab 134. As is illustrated, when the user display screen 102 switches from the QUICK HOLD mode to the TEMPORARY HOLD mode, the QUICK HOLD tab 132 changes from the selected condition to the unselected condition and the TEMPORARY HOLD tab 134 changes from the unselected condition to the selected condition. This is evidenced by the fact that the selected TEMPORARY HOLD tab 134 is displayed as being integral with information display portion 144 of the user display screen 102, and the QUICK HOLD tab 132 is displayed as being separated from the information display portion 144 by lines 151 and 153. In an embodiment, the selected tabs are displayed by being highlighted and the unselected tabs are displayed as unhighlighted.

In the TEMPORARY HOLD mode, the thermostat 100 controls the HVAC system according to the settings of the TEMPORARY HOLD mode for a predetermined length of time. With the information for the TEMPORARY HOLD mode displayed, the user may program the electronic processor with preferred parameters relating to a TEMPORARY HOLD mode. As can be seen from FIG. 3, the user may program several parameters with this screen displayed. The user can set the time at which the thermostat exits the TEMPORARY HOLD mode, such as illustrated as 8:30 μM tomorrow. Furthermore, the user may program the reference set temperature used by the thermostat 100 to control the HVAC system while operating during the TEMPORARY HOLD mode, illustrated as 85 degrees. The time and temperature values can be adjusted by pressing the UP buttons 150, 152 or DOWN buttons 154, 156 on the user display screen 102 proximate to, and thereby corresponding to, the temperature and termination time, respectively.

When the user finishes programming the thermostat for the QUICK HOLD mode or the TEMPORARY HOLD mode, the user may return to the MAIN MENU screen (see FIG. 1) by pushing the HOME button 160 on the user display screen 102. Alternatively, the user may continue and program other modes. Specifically, the user may move to the VACATION HOLD mode and program appropriate settings for that mode. To switch to the VACATION HOLD mode, the user simply selects, by touching, the VACATION HOLD tab 136. Once the VACATION HOLD tab 136 is touched, the display will change from either the QUICK HOLD mode screen (FIG. 2) or TEMPORARY HOLD mode screen (FIG. 3) to the VACATION HOLD mode screen (FIG. 4). The VACATION HOLD tab 136 will switch to the selected condition and the other tabs 132, 134 will be displayed in the unselected condition.

Another example where the tabbed configuration of the present invention may be implemented is a list of options that is too long to be entirely displayed in the information display region 144 of the user display screen 102. In previous thermostats, such lengthy lists would include a scroll bar or scrolling buttons proximate the list and the user would be required to scroll up and down through the list to locate a desired item in the list or piece of information. Unfortunately, as the user scrolled through the list the user could lose track of where in the list the user was reading. Specifically, because the user may not know if the entire displayed portion of the list is being replaced by an entirely new portion of the list or if a predetermined number of elements in the list were being changed, such as one at a time while scrolling. The present invention beneficially switches between individual pages of the list having entirely new information and selections.

For example, if the user selects the USER SETTINGS button 164 on the MAIN MENU (see FIG. 1), a portion of a list of USER SETTINGS that are user programmable or selectable are displayed. As illustrated by FIGS. 5 and 6, the list includes enough entries that it is long enough that the list is not entirely viewable in the information display portion 144 of user display screen 102. The list of user programmable settings includes TEMPERATURE SCALE for setting the temperature scale that temperatures are displayed in by the thermostat 100; LANGUAGE for setting the language that information will be displayed in by the thermostat 100; temperature OFFSET for setting the variation in temperature away from the set temperature at which the thermostat will activate the HVAC system; RESOLUTION for setting the number of decimal places that temperatures will be displayed with by the thermostat 100; SHOW SET TEMPERATURE for toggling between showing and not showing the current temperature and the set temperature when on the MAIN MENU screen; and SERVICE REMINDERS for which the user can program the service reminders that the user prefers the thermostat 100 to generate, such as maintenance to the HVAC system including replacing filters or cleaning the furnace and the like.

After pressing the USER SETTINGS button 164 on the MAIN MENU (FIG. 1), the first page of the list appears (FIG. 5). The illustrated display includes a first tab 170 labeled “1 of 2” and a second tab labeled “2 of 2” displayed in the tab region 140, which identify different groupings of selectable settings. Each grouping makes up a portion of the list. As illustrated, the user display screen 102 further has one of the groupings of selectable settings displayed in the information display region 144. This configuration beneficially identifies that the list includes a second page such that more selectable options are available than just the options displayed on the user display screen 102.

With the present invention, the user may easily switch between the different pages of the list, FIGS. 5 and 6, to select between the different USER SETTINGS that need to be adjusted. Specifically, after reviewing the first page of optional selections, if none of the options have been selected, the user may move to an entirely new page of the list having completely new information by selecting the second tab 172. Because the user has selected this second tab 172 and changed the user displayed screen 102 to an entirely new grouping of information, the user is not required to keep track of what information on the screen has been read, as can be necessary with a scrolling list interface. By knowing that all of the information displayed on the user display screen 102 is new unread information, the user is prevented from rereading previously read information significantly reducing time and confusion for the user. Specifically, as the pages are switched, it appears to the viewer that as if an entirely new screen or page is being viewed, or brought to the forefront, while the previously-viewed screen is being pushed behind the newly displayed screen. If the list only has a single page, only a single tab will be displayed. With only a single tab displayed, the user cannot attempt to switch to a new page because no button will be provided on the user display screen. Additionally, the user can easily jump back to the previous page by simply touching the first tab 170.

In an embodiment of the intelligent thermostat of the present invention, the electronic processor of the thermostat is programmed to store contact information. The contact information may include phone numbers, email addresses, and other personal contact information, which can be used by the user or the thermostat to either contact a repair technician, the manufacturer of the HVAC system, the manufacturer of the thermostat, or even the user. Specifically, if an error is monitored by the thermostat or HVAC system, the thermostat may be programmed to display an error message and an appropriate contact name and number to the user. Alternatively, the thermostat may be programmed to automatically use the input contact information to send the error message to the manufacturer or user. FIGS. 7 and 8 illustrate two screens that allow the user to input a contact name with a corresponding phone number.

To input such contact information, the user may select the CONTACT INFO button 178 from MAIN MENU (FIG. 1). After selecting the CONTACT INFO button 178, a first screen is displayed for inputting the contact NAME, as is illustrated in FIG. 7. On this screen the NAME tab 178 is displayed in a selected condition and a NUMBER tab 179 is displayed in an unselected condition. The user display screen 102 further displays a 12 button alphanumeric grid 180 in the information display region 140. The 12 button alphanumeric grid 180 includes letters, numbers and symbols on a majority of the buttons for inputting the name of the contact. Further, the letters are disposed above the numbers because the letters will typically be used more frequently while inputting the contact names.

To switch to the contact NUMBER screen to input a corresponding contact NUMBER for the previously entered contact NAME, the user selects, by pressing/touching, the NUMBER tab 179. After selecting the NUMBER tab 179, the NUMBER tab 179 changes from the unselected condition to the selected condition, as illustrated in FIG. 8. Furthermore, a similar 12 button alphanumeric grid 182 is displayed in the information display region 144, however, because numbers will be most frequently entered, the numbers on the buttons of the 12 button alphanumeric grid 182 are positioned above the letters The tabbed configuration allows the user to easily toggle between the NAME screen to the NUMBER screen, while beneficially using the majority of the information display region 144 to display the appropriate alphanumeric touch pad for the information being input into the thermostat.

The previously disclosed uses for a tabbed interface are only illustrative of the present invention the present invention is not so limited. As will be apparent to one of skill in the art in view of this description, other types of information may be displayed using the tabbed interface. Such information may relate to time of day programming, specific appliance programming, sensor programming and the like.

With reference to FIG. 9, in the embodiment in which the touch screen is not used, the soft keys 204-212 are used to input info into the thermostat 200 as opposed to the user display screen 202 itself. Here, a soft key proximate a desired tab representing desired information to be displayed can be used to select the tab and display the corresponding information. Specifically, with the illustrated embodiment, to move from the first page of the list to a second page of a list, the user would push soft key 208, which represents and is proximate to the second tab, the “2 of 2” tab 272. Thus, the tabbed display of this embodiment functions substantially the same in this embodiment as the previous embodiment; however, switching between screens is different because the user pushes buttons external to the screen as opposed to directly pressing/touching the user display screen. If the user would then like to switch back to the first page of the list, i.e. page “1 of 2” he would push soft key 204 which is positioned proximate the “1 of 1” tab. The other soft keys 210-212 may be used to move, vertically for instance, between the fields and options displayed on the screen 202. In an alternate embodiment, the user could select soft key 208 to cycle between the tabs from left to right, and soft key 204 to cycle between the tabs from right to left.

As the previous embodiment is described with reference to a dot matrix LCD display, one of skill in the art will appreciate that the embodiment could utilize other user display screens such as a static-LCD display. In such a user display, the tabs and text within the tabs would be permanently defined in the user display and the controller of the thermostat would selectively activate the tabs and text corresponding to selected settings or modes.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A thermostat for controlling a heating, ventilating and air conditioning (HVAC) system, comprising:
a controller;
a user display screen on which the controller displays information;
at least one user input device for relaying user selections to the controller; and
wherein the controller is programmed to display at least one tabbed visual identifier representing a first grouping of the information on the user display screen.

2. The thermostat of claim 1, wherein the user display screen is a liquid crystal display (LCD) and the at least one user input device includes at least one soft key.

3. The thermostat of claim 1, wherein the user display screen and the at least one user input device comprise a touch screen.

4. The thermostat of claim 3, wherein the at least one tabbed visual identifier includes a plurality of tabbed visual identifiers, each tabbed visual identifier identifying an individual grouping of information, and wherein each visual tabbed identifier defines a touch screen button, wherein the user may switch between the individual groupings of information by pressing the portion of the user display screen displaying the tabbed visual identifier identifying the desired grouping of information.

5. The thermostat of claim 4, wherein the individual groupings of information are discrete portions of a list.

6. The thermostat of claim 1, wherein the displayed at least one tabbed visual identifier is positioned proximate an edge of the user display screen.

7. The thermostat of claim 2, wherein the at least one soft key is positioned proximate the position where the at least one tabbed visual identifier is displayed.

8. The thermostat of claim 1, wherein the at least one tabbed visual identifier includes a plurality of tabbed visual identifiers, each tabbed visual identifier identifying an individual grouping of information.

9. The thermostat of claim 8, wherein each of the plurality of tabbed visual identifiers have a selected condition wherein the grouping of information that the tabbed visual identifier identifies is displayed on the user display screen and an unselected condition when the grouping of information that the identifier identifies is not displayed on the user screen.

10. The thermostat of claim 9, wherein in the selected condition, the tabbed visual identifier is displayed as being integral with the portion of the screen displaying the grouping of information identified by the selected tabbed visual identifier and the visual identifiers in the unselected condition and are displayed as being separated from the selected tabbed visual identifier and the portion of the screen displaying the grouping of information.

11. The thermostat of claim 10, wherein the separation is provided by at least one line extending from the tabbed portion toward an edge of the user display screen, the line being spaced inward from the edge in which the tabbed portion is proximate.

12. The thermostat of claim 9, wherein the selected one of the plurality of tabbed visual identifiers is highlighted when in the selected condition and the unselected tabs of the plurality of tabbed visual indicators are not highlighted when in the unselected condition.

13. The thermostat of claim 4, wherein the individual groupings of information include information for individual operational modes.

14. The thermostat of claim 4, wherein the individual groupings of information include information for individual portions of contact information.

15. The thermostat of claim 8, wherein the plurality of tabbed visual identifiers are equally sized and justified across the user display screen.

16. A method of displaying information on a user display of a thermostat, comprising the step of displaying a first grouping of information and a tabbed visual identifier on the user display screen corresponding to and identifying the displayed grouping of information.

17. The method of claim 16, wherein the step of displaying includes displaying a plurality of tabbed visual identifiers on the user display screen, wherein one of the displayed tabbed visual identifiers identifies the first grouping of information and the other ones of the displayed tabbed visual identifiers identify groupings of information that are not displayed on the user display screen.

18. The method of claim 17, further comprising the step of switching the displayed grouping of information from the first grouping to one of the undisplayed groupings by selecting a user input device corresponding to one of the other ones of the displayed tabbed visual identifiers.

19. The method of claim 18, wherein selecting a user input device includes pressing a displayed tabbed visual identifier on the user display screen, the user display screen being a touch screen.

20. The method of claim 18, wherein selecting a user input device includes pressing a soft key of the thermostat positioned proximate the displayed tabbed visual identifier on the display screen.
